(19) United States
(12) Patent Application Publication
(10) Pub. No.: US 2026/0058684 A1
(43) Pub. Date: Feb. 26, 2026

(54) COMMUNICATION DEVICE

(71) Applicant: WISTRON NEWEB CORPORATION, HSINCHU (TW)

(72) Inventors: LAN-CHUN YANG, HSINCHU (TW); YU-LIANG WENG, HSINCHU (TW)

(21) Appl. No.: 19/008,746

(22) Filed: Jan. 3, 2025

(30) Foreign Application Priority Data
Aug. 21, 2024 (TW) 113131370

(51) Int. Cl. H04B 1/40

(52) U.S. Cl. CPC H04B 1/40

(57) ABSTRACT

A communication device includes a base and a signal transceiver device. The signal transceiver device is disposed on the base. The signal transceiver device includes a dish element, a focusing surface bracket, a signal transceiver element, a support assembly and two pivot members. The dish element includes a reflective surface and a back surface located on opposite sides. The focusing surface bracket has a focusing surface, and the focusing surface faces the reflective surface. The signal transceiver element is disposed on the focusing surface. The support assembly is connected to the back surface of the dish element, and a portion of the support assembly extends from the dish element for connecting to the focusing surface bracket. Each pivot member is connected to the base and the portion of the support assembly extending from the dish element.

### CROSS-REFERENCE TO RELATED PATENT APPLICATION

This application claims the benefit of priority to Taiwan Patent Application No. 113131370, filed on Aug. 21, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### FIELD OF THE PRESENT DISCLOSURE

The present disclosure relates to a communication device, particularly to a communication device with integrally formed internal components.

### BACKGROUND OF THE PRESENT DISCLOSURE

Customer-premises equipment (CPE) refers to network terminal devices located at the user end for interfacing with telecommunications operator equipment. CPE devices can include servers, modems, routers, and the like. Existing CPE devices generally have an internal micro-antenna mechanism, where the micro-antenna mechanism is assembled from multiple separate components. The production involves manufacturing individual components one by one and then assembling them, resulting in higher manufacturing costs.

Furthermore, the micro-antenna mechanism mainly includes a dish-shaped antenna and an antenna bracket assembled together. The dish-shaped antenna is fixed to the antenna bracket using screws. However, fixing with screws reduces the reflective surface area of the dish-shaped antenna, because the screws need to penetrate the surface of the dish-shaped antenna to be fixed to the antenna bracket.

Therefore, improving the structural design to overcome the above-mentioned drawbacks has become an important issue to be addressed in this field.

### SUMMARY OF THE PRESENT DISCLOSURE

The technical problem to be solved by the present disclosure is to provide a communication device with integrally formed internal components to address the deficiencies of prior art.

To solve the above technical problem, one of the technical solutions adopted by the present disclosure is to provide a communication device, which includes a base and a signal transceiver device. The signal transceiver device is arranged on the base. The signal transceiver device includes a dish element, a focusing surface bracket, a signal transceiver element, a support assembly, and two pivot members. The dish element has a reflective surface and a back surface located on opposite sides. The focusing surface bracket has a focusing surface facing the reflective surface. The signal transceiver element is arranged on the focusing surface. The support assembly is connected to the back surface of the dish element, with a portion of the support assembly extending from the dish element to connect to the focusing surface bracket. Each pivot member is connected to the base and the portion of the support assembly extending from the dish element. The dish element, focusing surface bracket, and support assembly are formed in one piece.

One beneficial effect of the present disclosure is that the provided communication device includes a signal transceiver device constructed from an integrally formed dish element, focusing surface bracket, and support assembly. The present disclosure reduces manufacturing costs, assembly errors, and assembly time by improving the signal transceiver device into an integrally formed structure. Additionally, since the dish element and the focusing surface bracket are integrally formed, the surface of the dish element (i.e., reflective surface) does not require perforations for screws, thus preserving the maximum reflective area.

To further understand the features and technical content of the present disclosure, please refer to the following detailed description and drawings. The provided drawings are for reference and illustration only and are not intended to limit the present disclosure.

### BRIEF DESCRIPTION OF THE DRAWINGS

The described embodiments may be better understood by reference to the following description and the accompanying drawings, in which:

FIG. 1 is a schematic of the communication device according to a first embodiment of the present disclosure.

FIG. 2 is a first schematic of the signal transceiver device according to the first embodiment of the present disclosure.

FIG. 3 is a second schematic of the signal transceiver device according to the first embodiment of the present disclosure.

FIG. 4 is a schematic of the signal transceiver device connected to a motor assembly according to the first embodiment of the present disclosure.

FIG. 5 is a schematic of the signal transceiver device according to a second embodiment of the present disclosure.

FIG. 6 is a schematic of the signal transceiver device according to a third embodiment of the present disclosure.

FIG. 7 is a schematic of the signal transceiver device according to a fourth embodiment of the present disclosure.

FIG. 8 is a schematic of the signal transceiver device according to a fifth embodiment of the present disclosure.

FIG. 9 is a schematic of the signal transceiver device connected to a motor assembly according to the fifth embodiment of the present disclosure.

### DETAILED DESCRIPTION OF THE EXEMPLARY EMBODIMENTS

The following describes the embodiments of the disclosed “communication device” in detail through specific examples. The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like. Furthermore, the term “or” as used herein should be understood as including any combination of the associated listed items. Additionally, the term “connect” throughout the present disclosure means that two elements are physically connected, either directly or indirectly.

### First Embodiment

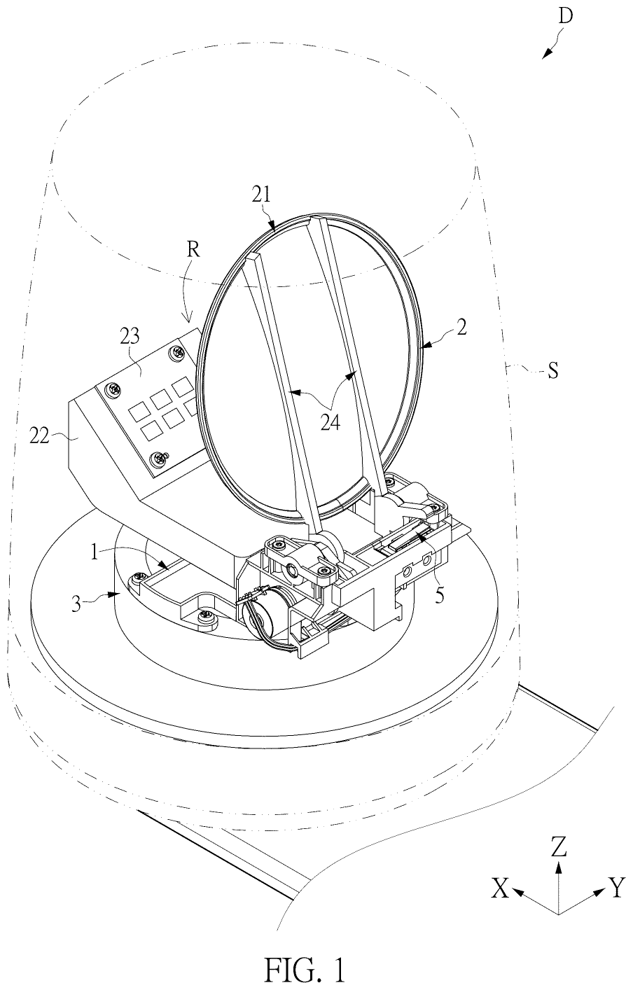

Referring to FIG. 1, FIG. 1 is a schematic of the communication device according to a first embodiment of the present disclosure. The first embodiment of the present disclosure provides a communication device D, which includes a housing S, a base 1, a signal transceiver device 2, and a rotating pedestal 3. The base 1, signal transceiver device 2, and rotating pedestal 3 are arranged inside the housing S, with the signal transceiver device 2 installed on the base 1 and fixed to the rotating pedestal 3 through the base 1. As shown in FIG. 1, driven by the rotating pedestal 3, the signal transceiver device 2 can rotate around an axis (Z-axis) to be adjusted to face different orientations.

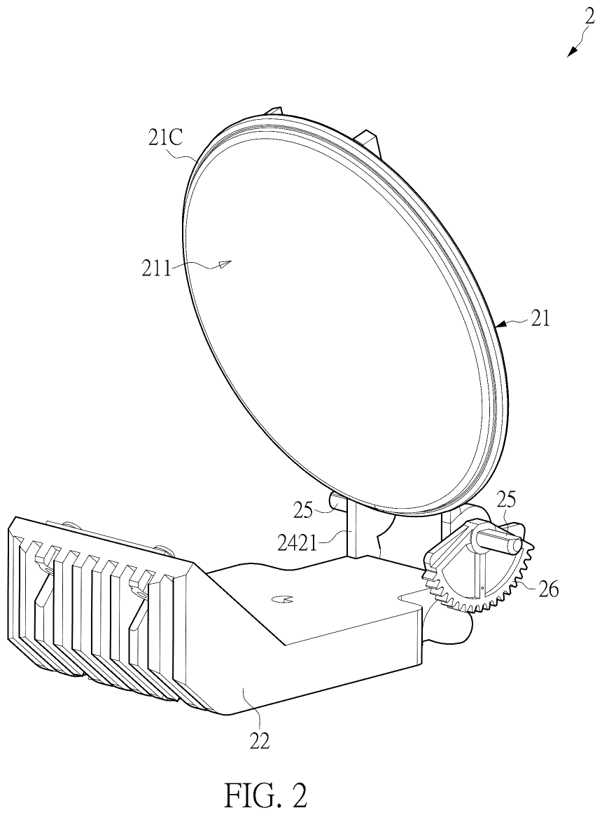

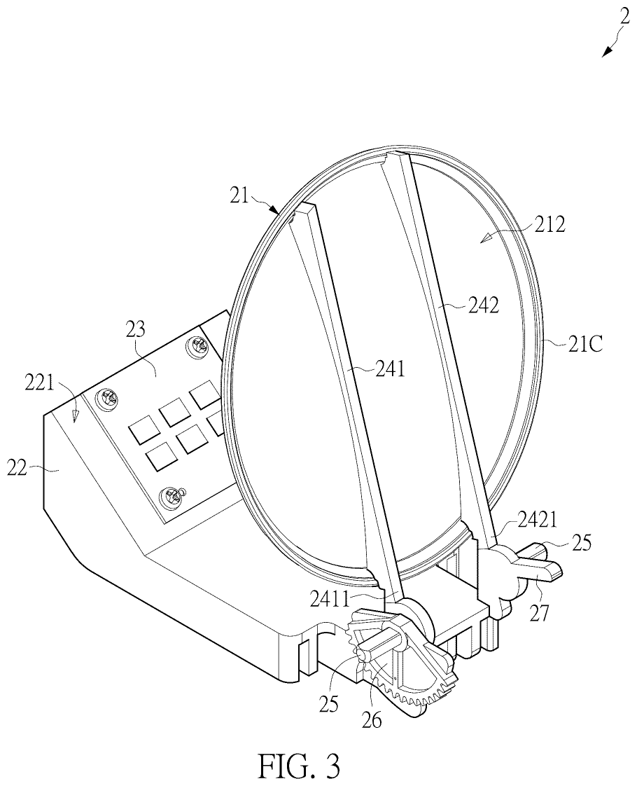

Referring to FIG. 2 and FIG. 3, FIG. 2 and FIG. 3 are schematics of the signal transceiver device according to the first embodiment of the present disclosure. The signal transceiver device 2 includes a dish element 21, a focusing surface bracket 22, a signal transceiver element 23, and a support assembly 24. The dish element 21 has a reflective surface 211 and a back surface 212 located on opposite sides, with the reflective surface 211 being a parabolic surface. The focusing surface bracket 22 has a focusing surface 221, with the focusing surface 221 facing the reflective surface 211 of the dish element 21. The signal transceiver element 23 is arranged on the focusing surface 221.

For example, the signal transceiver device 2 is an offset antenna system, with the focusing surface 221 positioned right at the focal point of the reflective surface 211 (parabolic surface) of the dish element 21. Additionally, for example, the signal transceiver element 23 can be an array antenna, but the present disclosure is not limited to the specific form of the signal transceiver element 23. Through the configuration of the focusing surface 221 and the reflective surface 211, the signal transceiver element 23 can receive/transmit signals through the dish element 21. Using signal reception as an example, a ground transmitting station (not shown) can transmit a signal, which is relayed to the signal transceiver device 2 through a satellite antenna (not shown) and then reflected by the reflective surface 211 of the dish element 21 to the signal transceiver element 23 located at the focusing surface 221, where the signal is received by the signal transceiver element 23.

The support assembly 24 is connected to the back surface 212 of the dish element 21, with a portion of the support assembly 24 extending from the dish element 21 to connect to the focusing surface bracket 22. In the present disclosure, the dish element 21, focusing surface bracket 22, and support assembly 24 are integrally formed; that is, the signal transceiver device 2 is an integrally formed structure. The signal transceiver device 2 of the present disclosure is formed using a die-casting process. Die casting is a process of injecting molten metal into a mold. During production, a die-casting mold is manufactured according to the product design (i.e., the product design of the signal transceiver device 2). Then, suitable metals (such as zinc, aluminum, copper alloys, etc.) are selected and heated to a molten state suitable for die casting. Then, the molten metal is injected into the mold cavity through an injection system, where the molten metal will quickly fill the mold cavity through a channel in the mold cavity under high pressure. Then, after cooling and solidifying, the solidified metal component (i.e., the formed signal transceiver device 2) is removed. After post-processing (such as deburring and surface treatment), the manufacture of the product, i.e., the signal transceiver device 2 is completed.

It is worth mentioning that when using the die-casting process to manufacture the signal transceiver device 2, the contour of the mold cavity includes the shapes of the dish element 21 and the focusing surface bracket 22, while the channel in the mold cavity is the shape of the support assembly 24. In other words, the design of the channel is the structural design of the support assembly 24. As shown in FIG. 2 and FIG. 3, the support assembly 24 includes a first connecting rib 241 and a second connecting rib 242 that are parallel to each other and arranged longitudinally. The first connecting rib 241 includes a first extension portion 2411, and the second connecting rib 242 includes a second extension portion 2421. The first extension portion 2411 and the second extension portion 2421 are portions of the support assembly 24 extending from the dish element 21 to connect to the focusing surface bracket 22. Furthermore, each of the first connecting rib 241 and the second connecting rib 242 intersects the periphery 21C of the dish element 21 at two points.

Therefore, the present disclosure uses the die-casting mold channel design to allow the channel to simultaneously connect the cavity with the shape of the dish element 21 and the cavity with the shape of the focusing surface bracket 22 in the mold, thereby making the filling flow rates and cooling rates of the dish element 21 and the focusing surface bracket 22 close. Additionally, the present disclosure can further use the channel design to allow the metal components filled in the channel to solidify and form the support assembly 24 (first connecting rib 241 and second connecting rib 242) that connects the dish element 21 and the focusing surface bracket 22, making the dish element 21, focusing surface bracket 22, and support assembly 24 an integrally formed structure. This not only reinforces the structural strength of the formed dish element 21 but also further reduces the overall manufacturing cost of the signal transceiver device 2, and reduces assembly errors and assembly time.

Continuing to refer to FIG. 2 and FIG. 3, the signal transceiver device 2 further includes two pivot members 25, each pivot member 25 connected to the base 1 and to the portion of the support assembly 24 extending from the dish element 21 for connecting to the focusing surface bracket 22, i.e., the two pivot members 25 are respectively connected to the first extension portion 2411 and the second extension portion 2421. Additionally, the support assembly 24 (first connecting rib 241 and second connecting rib 242) and the two pivot members 25 are also integrally formed. The present disclosure is not limited to the form of the pivot members 25; for example, the pivot members 25 can be a connecting rod or an insertion slot.

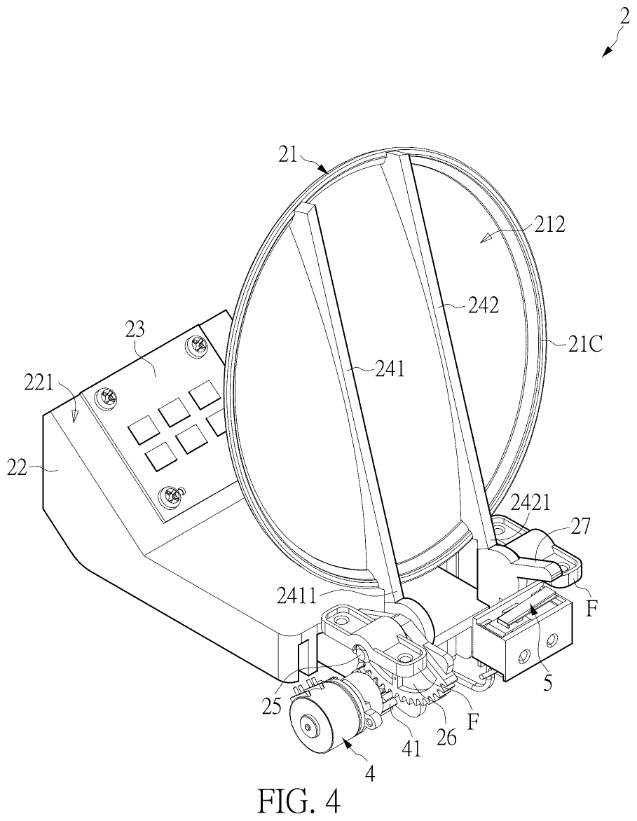

Referring to FIG. 1 and FIG. 4, FIG. 4 is a schematic of the signal transceiver device connected to a motor assembly according to the first embodiment of the present disclosure. In this embodiment, both pivot members 25 are connecting rods, which can respectively be movably inserted into two fixed members F, allowing the signal transceiver device 2 to be installed on the base 1 through the fixed members F and to pivot around the two pivot members 25. Additionally, the signal transceiver device 2 includes a gear disk 26, which is connected to one of the pivot members 25. The communication device D of the present disclosure includes a motor assembly 4, the motor assembly 4 including a gear member 41. The motor assembly 4 is connected to the gear disk 26 through the gear member 41, so as to drive the signal transceiver device 2 to rotate around the pivot members 25.

Furthermore, the pivot members 25 and the gear disk 26 are located in a clearance region R between the reflective surface 211 of the dish element 21 and the focusing surface 221. Specifically, the clearance region R is the signal transmission region, so the pivot members 25 and the gear disk 26 need to be designed to be located outside the clearance region R, so as to avoid obstructing signal transmission between the reflective surface 211 and the focusing surface 221.

Continuing to refer to FIG. 1 and FIG. 4, the communication device D also includes a brake switch 5, the brake switch 5 being electrically connected to the motor assembly 4. The brake switch 5 faces the back surface 212 of the dish element 21. The signal transceiver device 2 further includes a limit rod 27, the limit rod 27 being connected to the portion of the support assembly 24 extending from the dish element 21; as shown in FIG. 4, the limit rod 27 is connected to the second extension portion 2421. Specifically, when the signal transceiver device 2 is driven by the motor assembly 4 to pivot around the pivot members 25, the limit rod 27 will be driven to rotate synchronously and press against the brake switch 5, causing the brake switch 5 to output a control signal to the motor assembly 4 to stop its operation.

It should be noted, however, that the above-mentioned embodiment related to the signal transceiver device 2 is merely one of the feasible embodiments and is not intended to limit the present disclosure. In subsequent embodiments, different implementations of the signal transceiver device 2 will be further described. Moreover, all subsequently listed implementations of the signal transceiver device 2 can be suitably applied to the communication device D of the present disclosure, i.e., they can be installed inside the housing S and mounted on the base 1, and fixed through the base 1 to the rotating pedestal 3 that can rotate.

### Second Embodiment

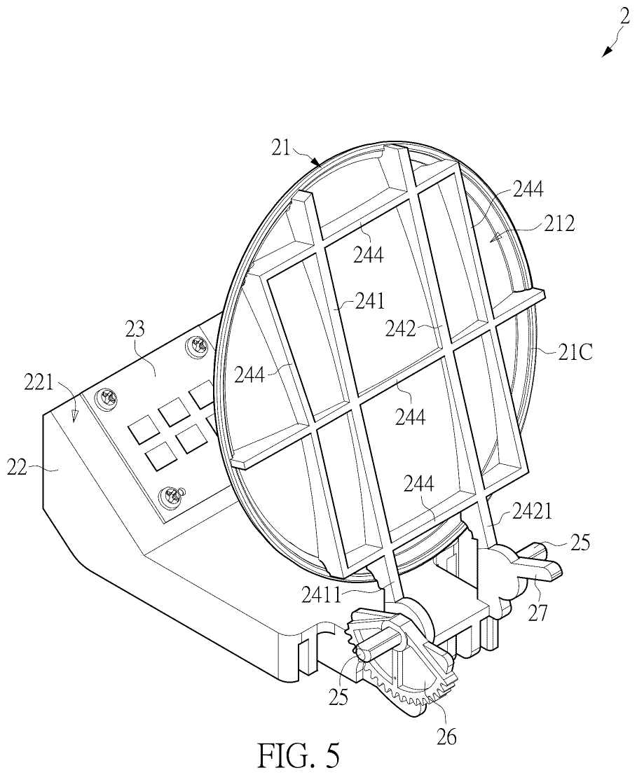

Referring to FIG. 5, FIG. 5 is a schematic of the signal transceiver device according to a second embodiment of the present disclosure. The signal transceiver device 2 of the second embodiment has a structure similar to that of the first embodiment (see FIG. 3), and the similar parts will not be repeated herein. Compared with the first embodiment, in the signal transceiver device 2 of the second embodiment, the support assembly 24 further includes multiple support ribs 244. The multiple support ribs 244 are arranged in a longitudinal or transverse direction on the back surface 212 of the dish element 21.

Specifically, in addition to the first connecting rib 241 and second connecting rib 242 arranged longitudinally, the support assembly 24 further includes three support ribs 244 arranged transversely and configured with a fixed spacing, as well as two support ribs 244 arranged longitudinally and configured with a fixed spacing. The first connecting rib 241 and the second connecting rib 242 are located between the two longitudinally arranged support ribs 244, and the three transversely arranged support ribs 244 are vertically connected to the first connecting rib 241, the second connecting rib 242, and the two longitudinally arranged support ribs 244. Furthermore, each support rib 244 intersects the periphery 21C of the dish element 21 at two points. Through the structural design of multiple support ribs 244, the present disclosure increases the flow rate of the molten metal during die casting, and reinforces the structural strength of the formed dish element 21.

### Third Embodiment

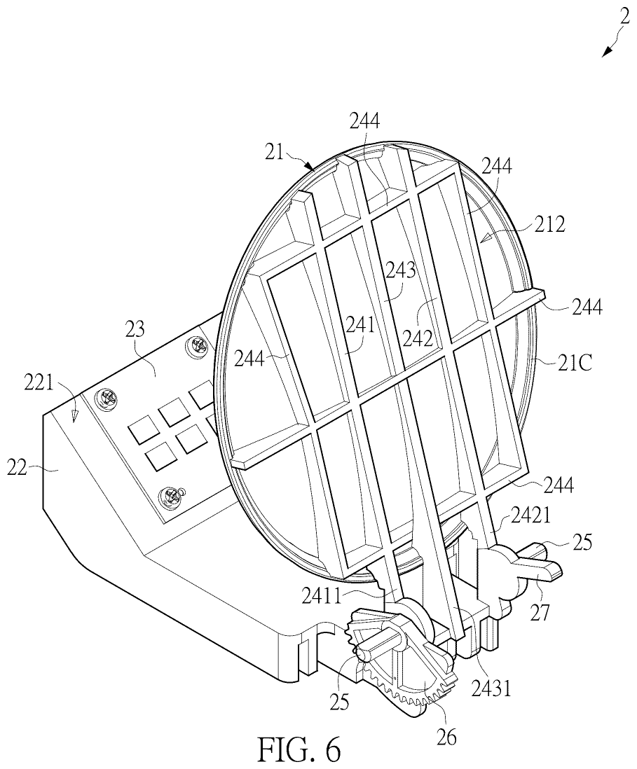

Referring to FIG. 6, FIG. 6 is a schematic of the signal transceiver device according to a third embodiment of the present disclosure. The signal transceiver device 2 of the third embodiment has a structure similar to that of the second embodiment (see FIG. 5), and the similar parts will not be repeated herein. Compared with the second embodiment, in the signal transceiver device 2 of the third embodiment, the support assembly 24 further includes a third connecting rib 243. The third connecting rib 243 is arranged parallel between the first connecting rib 241 and the second connecting rib 242. The third connecting rib 243, the first connecting rib 241, the second connecting rib 242, and the two longitudinally arranged support ribs 244 are configured with a fixed spacing. The third connecting rib 243 includes a third extension portion 2431, the third extension portion 2431 extending from the dish element 21 to connect to the focusing surface bracket 22. Through the structural design of the third connecting rib 243, the present disclosure can increase the flow rate of the molten metal during die casting, and reinforce the structural strength of the formed dish element 21. Additionally, the present disclosure can further reinforce the connection strength between the dish element 21 and the focusing surface bracket 22 via the third extension portion 2431 of the third connecting rib 243 that extends from the dish element 21.

### Fourth Embodiment

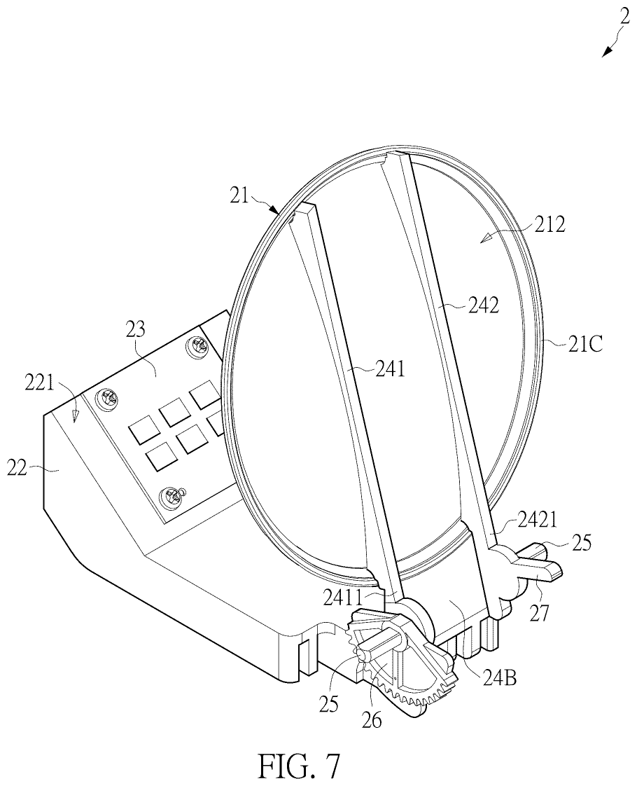

Referring to FIG. 7, FIG. 7 is a schematic of the signal transceiver device according to a fourth embodiment of the present disclosure. The signal transceiver device 2 of the fourth embodiment has a structure similar to that of the first embodiment (see FIG. 3), and the similar parts will not be repeated herein. Compared with the first embodiment, in the signal transceiver device 2 of the fourth embodiment, a filling portion 24B is arranged between the first extension portion 2411 and the second extension portion 2421. In other words, during the die-casting process, the form of the mold cavity is changed, so as to allow molten metal to fill in between the first extension portion 2411 and the second extension portion 2421, causing a formed filling portion 24B being connected between the first extension portion 2411 and the second extension portion 2421, so as to increase the flow rate of the molten metal during die casting and reinforce the structural strength of the formed dish element 21.

### Fifth Embodiment

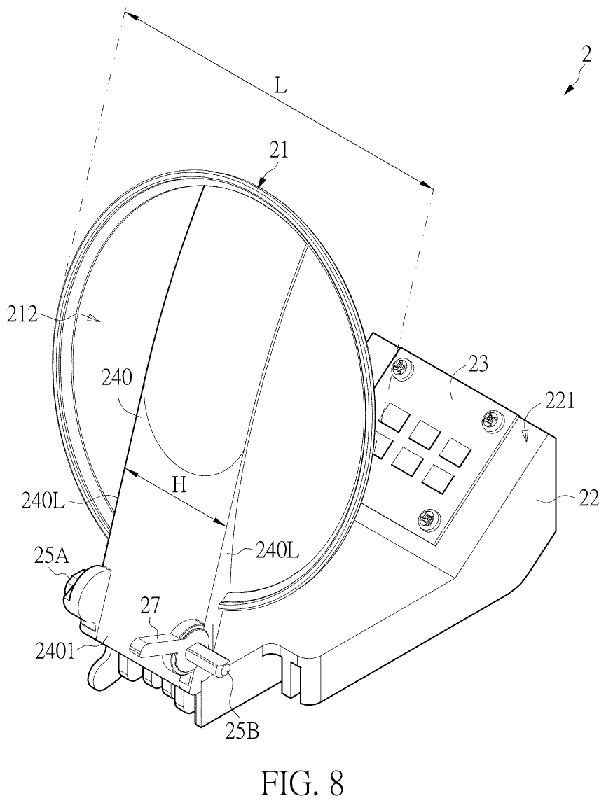

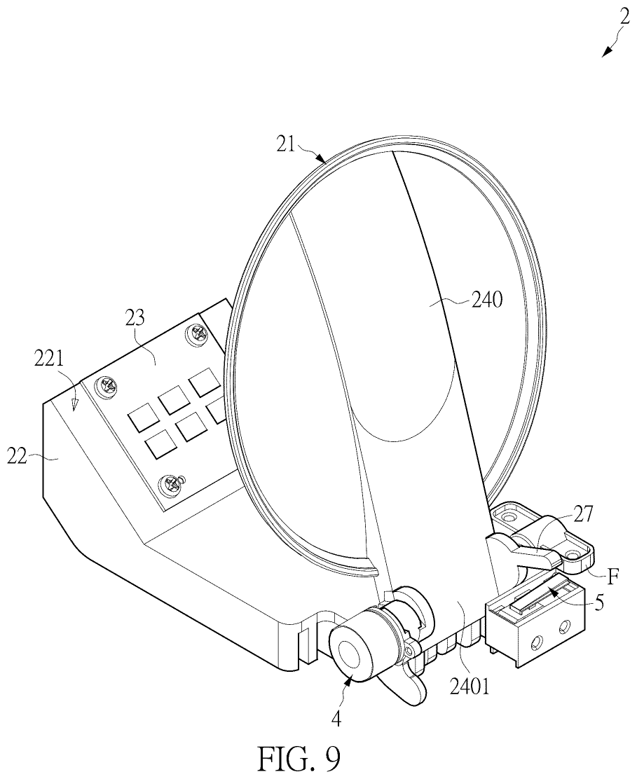

Referring to FIG. 8 and FIG. 9, FIG. 8 is a schematic of the signal transceiver device according to a fifth embodiment of the present disclosure, and FIG. 9 is a schematic of the signal transceiver device connected to a motor assembly according to the fifth embodiment of the present disclosure. The signal transceiver device 2 of the fifth embodiment has a structure similar to that of the fourth embodiment (see FIG. 7), and the similar parts will not be repeated herein. Compared with the fourth embodiment, in the signal transceiver device 2 of the fifth embodiment (see FIG. 8), the support assembly 24 only has one connecting rib 240. The connecting rib 240 is arranged in the middle position of the back surface 212 of the dish element 21. The connecting rib 240 only includes one extension portion 2401, the extension portion 2401 being the portion of the support assembly 24 extending from the dish element 21, wherein the dish element 21 is connected to the focusing surface bracket 22 through the extension portion 2401.

During manufacturing, the area between the two channels forming the first connecting rib 241 and the second connecting rib 242 in FIG. 7 is connected to form a widened channel; the connecting rib 240 can be formed after molten metal flows through the widened channel and solidifies. Specifically, the connecting rib 240 intersects the periphery 21C of the dish element 21 at two points. The connecting rib 240 has two long sides 240L, and a predetermined distance H is between the two long sides 240L. In a preferred embodiment, the predetermined distance H is equal to 25% to 35% of the diameter L of the dish element 21. Through the widened channel design, the flow rate of molten metal during die casting can be increased, and the width of the formed connecting rib 240 is further increased, thereby reinforcing the structural strength of the formed dish element 21 and the connection strength between the dish element 21 and the focusing surface bracket 22.

Additionally, in this embodiment, the signal transceiver device 2 includes two pivot members 25A and 25B connected to the extension portion 2401. The pivot member 25A is a connection slot for direct insertion of a transmission shaft (not shown) of the motor assembly 4. The pivot member 25B is a connecting rod for movably inserting into the fixed member F. The signal transceiver device 2 is installed on the base 1 through the fixed member F, and the motor assembly 4 directly drives, through its transmission shaft, the signal transceiver device 2 to rotate around the pivot member 25. Compared with the fourth embodiment (see FIG. 7), the signal transceiver device 2 of this embodiment omits the design of the gear disk 26.

### Beneficial Effects of the Embodiments

The communication device D provided by the present disclosure includes a signal transceiver device 2 constructed from an integrally formed dish element 21, focusing surface bracket 22, and support assembly 24. By improving the signal transceiver device 2 into an integrally formed structure, the present disclosure reduces manufacturing costs, assembly errors, and assembly time. Additionally, since the dish element 21 and the focusing surface bracket 22 are integrally formed, the surface (i.e., reflective surface) of the dish element 21 does not require perforations for screws, thus preserving the maximum reflective area.

Furthermore, the present disclosure uses a die-casting mold channel design to allow the channel to simultaneously connect the cavity with the shape of the dish element 21 and the cavity with the shape of the focusing surface bracket 22 in the mold, thereby making the filling flow rates and cooling rates of the dish element 21 and the focusing surface bracket 22 close. Additionally, the present disclosure can further use the channel design to allow the metal components filled in the channel to solidify and form the support assembly 24 (first connecting rib 241 and second connecting rib 242) that connects the dish element 21 and the focusing surface bracket 22, making the dish element 21, focusing surface bracket 22, and support assembly 24 an integrally formed structure. This not only reinforces the structural strength of the formed dish element 21 but also further reduces the overall manufacturing cost of the signal transceiver device 2, and reduces assembly errors and assembly time.

The foregoing description of the exemplary embodiments of the present disclosure has been presented only for the purposes of illustration and description and is not intended to be exhaustive or to limit the present disclosure to the precise forms disclosed. Many modifications and variations are possible in light of the above teaching.

The embodiments were chosen and described in order to explain the principles of the present disclosure and their practical application so as to enable others skilled in the art to utilize the present disclosure and various embodiments and with various modifications as are suited to the particular use contemplated. Alternative embodiments will become apparent to those skilled in the art to which the present disclosure pertains without departing from its spirit and scope.

What is claimed is:

1. A communication device, comprising:
a base; and
a signal transceiver device arranged on the base, the signal transceiver device comprising:
a dish element having a reflective surface and a back surface located on opposite sides;
a focusing surface bracket having a focusing surface, the focusing surface facing the reflective surface;
a signal transceiver element arranged on the focusing surface;
a support assembly connected to the back surface of the dish element, wherein a portion of the support assembly extends from the dish element to connect to the focusing surface bracket; and
two pivot members, each of the pivot members connected to the base and to the portion of the support assembly extending from the dish element;
wherein the dish element, the focusing surface bracket, and the support assembly are integrally formed.

2. The communication device according to claim 1, further comprising a rotating pedestal, wherein the base is connected to the rotating pedestal.

3. The communication device according to claim 1, wherein the support assembly and the two pivot members are integrally formed.

4. The communication device according to claim 1, wherein the support assembly comprises a connecting rib arranged in a middle position of the back surface of the dish element, the connecting rib comprising an extension portion, the extension portion is the portion of the support assembly extending from the dish element, and the two pivot members are connected to the extension portion.

5. The communication device according to claim 4, wherein the connecting rib intersects a periphery of the dish element at two points.

6. The communication device according to claim 4, wherein the connecting rib has two long sides, a predetermined distance is between the two long sides, and the predetermined distance is 25% to 35% of a diameter of the dish element.

7. The communication device according to claim 1, wherein the support assembly comprises a first connecting rib and a second connecting rib parallel to each other, the first connecting rib comprises a first extension portion, the second connecting rib comprises a second extension portion, the first extension portion and the second extension portion are the portion of the support assembly extending from the dish element, and the two pivot members are respectively connected to the first extension portion and the second extension portion.

8. The communication device according to claim 7, wherein each of the first connecting rib and the second connecting rib intersects a periphery of the dish element at two points.

9. The communication device according to claim 7, wherein the support assembly further comprises multiple support ribs, and the multiple support ribs are arranged in a longitudinal direction or a transverse direction on the back surface of the dish element.

10. The communication device according to claim 7, wherein the support assembly further comprises a third connecting rib and multiple support ribs, the third connecting rib is arranged parallel between the first connecting rib and the second connecting rib, the third connecting rib comprises a third extension portion extending from the dish element to connect to the focusing surface bracket, and the multiple support ribs are arranged in a longitudinal direction or a transverse direction on the back surface of the dish element.

11. The communication device according to claim 10, wherein each of the third connecting rib and the multiple support ribs intersects a periphery of the dish element at two points.

12. The communication device according to claim 1, further comprising a motor assembly connected to one of the pivot members and configured to drive the signal transceiver device to rotate.

13. The communication device according to claim 1, further comprising a motor assembly, the motor assembly comprising a gear member, the signal transceiver device further comprising a gear disk connected to one of the pivot members, the motor assembly being connected to the gear disk through the gear member to drive the signal transceiver device to rotate.

14. The communication device according to claim 1, further comprising a motor assembly and a brake switch, the motor assembly directly or indirectly connected to one of the pivot members, the brake switch electrically connected to the motor assembly, the brake switch facing the back surface of the dish element, the signal transceiver device further comprising a limit rod connected to the portion of the support assembly extending from the dish element; wherein when the signal transceiver device is driven by the motor assembly to rotate, the limit rod rotates synchronously for pressing against the brake switch, causing the brake switch to control the motor assembly to stop operation.
